(19) United States
(12) Patent Application Publication
(10) Pub. No.: US 2024/0229856 A1
(43) Pub. Date: Jul. 11, 2024

(54) SYSTEM FOR FASTENING STRUCTURES TO A VEHICLE

(71) Applicant: Caterpillar SARL, Geneva (CH)

(72) Inventors: Andrew Ian CRAWFORD, Newcastle upon Tyne (GB); Adam Thomas KEBELL, Newcastle upon Tyne (GB)

(73) Assignee: Caterpillar SARL, Geneva (CH)

(21) Appl. No.: 18/285,804

(22) PCT Filed: Apr. 1, 2022
(86) PCT No.: PCT/EP2022/025129

§ 371 Date: Oct. 5, 2023

(30) Foreign Application Priority Data
Apr. 8, 2021 (GB) 2105033.1

(51) Int. Cl. F16B 41/00; F16B 43/00; F16B 45/00

(52) U.S. Cl. CPC F16B 41/002; F16B 43/00; F16B 45/002

(57) ABSTRACT

A fastener for fastening a structure to a work machine. The fastener has a threaded end for engaging with and fastening the structure to the work machine and a head to which a force can be applied to rotate the fastener and fasten it to the work machine. The fastener includes a washer that is retained on a non-threaded section of the fastener between the threaded end and the fastener head.

### TECHNICAL FIELD

The present disclosure relates to fastening a structure to a machine, such as an off-highway truck, an excavator, a bulldozer, or the like. More particularly, the present disclosure relates to a tethering system for tethering hardware, such as bolts, nuts, washers and/or the like, to the structure being fastened to the machine.

### BACKGROUND

Earth moving machines, such as articulated trucks, include multiple arrangements, such as radiator fan arrangements, and the like. A structure, such as a guard panel, may be generally applied to shield such arrangements from direct access (e.g., direct operator access). Typically, such a structure, as applied, is coupled or fastened to a machine portion via hardware that may include a number of components, such as fasteners and washers. Gathering such hardware together during assembling or disassembling of the structure is a challenging and time-consuming task, particularly if there are multiple fastening points on the structure and/or if the structure is relatively large. During assembling or disassembling the structure, if one or more of the fasteners and/or washers is lost or misplaced, reassembling and returning the structure to its original state on the machine portion becomes challenging, particularly at site locations where the surroundings are unclean and/or unorganized. Furthermore, during assembly of the structure on the machine, especially during machine manufacture, there may be assembly mechanisms with moving parts that may be damaged by contact with the structure hardware and/or may be dangerous to an assembler seeking such hardware during the assembly process.

U.S. Pat. No. 8,142,124 discloses a captive fastening system. The captive fastening system includes a bolt, a lock washer, a flat washer, a retainer, and a nut. The bolt includes a head, a threaded portion, and a shank extending therebetween. The head includes a circumferential groove configured to receive a snap-ring. An aperture extends through the snap-ring that is configured to receive a first end of a lanyard. In addition, a second end of the lanyard is coupled to a structure to which the bolt is to be retained.

### SUMMARY

In one aspect, the disclosure is directed to a system for fastening a structure to a portion of a machine. The system includes a fastener, a washer piece, and a flexible tether. The fastener defines a head portion and a shank portion. The shank portion defines a threaded portion and an unthreaded portion. The unthreaded portion extends between the head portion and the threaded portion. The washer piece is disposed around the unthreaded portion and is retained between the head portion and the threaded portion of the shank portion. The flexible tether includes a first end and a second end. The first end is coupled with the washer piece and the second end includes a retention member for securing the flexible tether to the structure.

In another aspect, the disclosure relates to a guard assembly for a machine. The guard assembly includes a structure defining an engagement portion. Also, the guard assembly includes a system for fastening the structure to a portion of the machine. The system includes a fastener, a washer piece, and a flexible tether. The fastener defines a head portion and a shank portion. The shank portion defines a threaded portion and an unthreaded portion. The unthreaded portion extends between the head portion and the threaded portion. The washer piece is disposed around the unthreaded portion and is retained between the head portion and the threaded portion of the shank portion. The flexible tether includes a first end and a second end. The first end is coupled with the washer piece and the second end includes a retention member for securing the flexible tether to the structure.

In yet another aspect, the disclosure relates to a machine. The machine includes a portion at least partially surrounding an arrangement. Also, the machine includes a guard assembly having a structure defining an engagement portion, and a system for fastening the structure to the portion of the machine. The system includes a fastener, a washer piece, and a flexible tether. The fastener defines a head portion and a shank portion. The shank portion defines a threaded portion and an unthreaded portion. The unthreaded portion extends between the head portion and the threaded portion. The washer piece is disposed around the unthreaded portion and is retained between the head portion and the threaded portion of the shank portion. The flexible tether includes a first end and a second end. The first end is coupled with the washer piece and the second end includes a retention member for securing the flexible tether to the structure.

Machines, such as large trucks, off-road trucks, bulldozers, excavators, tracked vehicles and/or the like, often comprise large/bulky structures, such as guards or the like, that are fastened to the vehicle to cover components, such as parts of the machine's engine, the machine's fan system, the machine's hydraulics, etc. These bulky structures must be attached to the machine during assembly and disassembled and re-assembled during machine maintenance. Machine assembly and/or machine maintenance may occur in conditions where loose hardware associated with the structures may be dangerous and handling of the loose hardware may be problematic and/or inefficient.

### BRIEF DESCRIPTION OF THE DRAWINGS

FIG. 1 illustrates an exemplary machine, in accordance with an embodiment of the present disclosure;

FIG. 2 illustrates an exemplary radiator housing of the machine, in accordance with an embodiment of the present disclosure;

FIG. 3 illustrates a guard assembly, including a structure and a system for fastening the structure to a portion of the radiator housing of the machine, in accordance with an embodiment of the present disclosure;

FIG. 4 illustrates a retention member of the system cooperating with an engagement portion of the structure, in accordance with an embodiment of the present disclosure;

FIG. 5 illustrates the system, in accordance with an embodiment of the present disclosure;

FIG. 6 illustrates the system, in accordance with another embodiment of the present disclosure;

FIG. 7 illustrates the system, in accordance with yet another embodiment of the present disclosure; and

FIG. 8 illustrates the system, in accordance with still another embodiment of the present disclosure.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts.

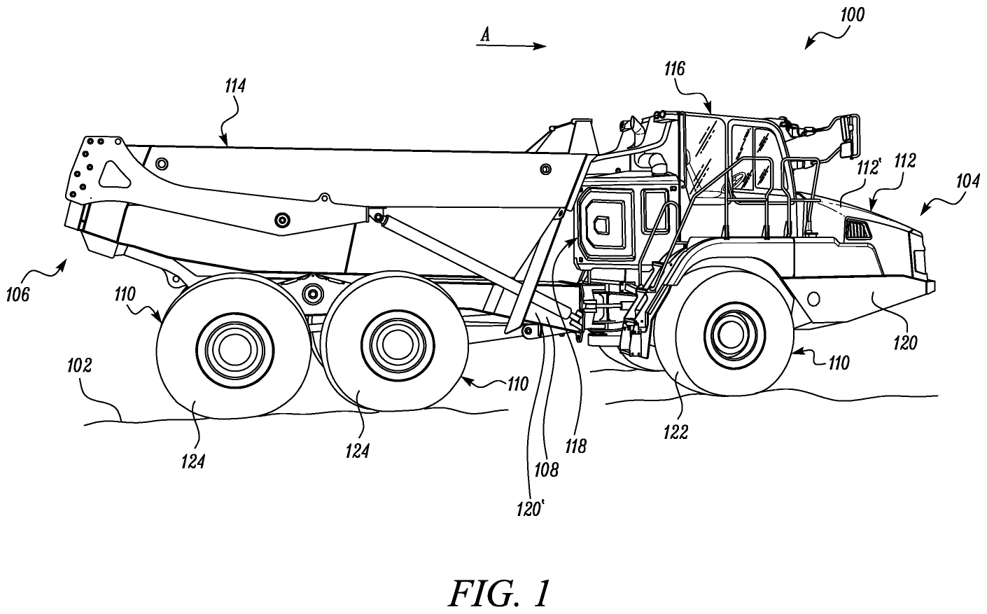

Referring to FIG. 1 an exemplary machine 100 is shown. The machine 100 operates at a worksite 102 that may include a mine site, a landfill, a quarry, a construction site, or any other type of worksite. The machine 100 may be an articulated truck, although one or more aspects of the present disclosure may be applied to other machines, such as off-highway trucks, haul trucks, dump trucks, loaders, excavators, and/or the like. Further, the machine 100 may be a manned machine or an unmanned machine.

As shown in FIG. 1, the machine 100 may include a forward end 104 and a rearward end 106 opposite to the forward end 104. The forward end 104 and the rearward end 106 may be defined in relation to an exemplary direction of travel of the machine 100 (indicated by an arrow ‘A’), with said direction of travel being defined from the rearward end 106 towards the forward end 104. Further, the machine 100 includes a frame 108, one or more ground-engaging members 110, a propulsion system 112, a dump body 114, an operator cabin 116, and a radiator housing 118.

The frame 108 may be a two-piece frame having a front frame portion 120 and a rear frame portion 120′ coupled to the front frame portion 120. The front frame portion 120 may accommodate and/or support the propulsion system 112, the operator cabin 116, and the radiator housing 118, although other known components and structures may be supported by the front frame portion 120, as well. The rear frame portion 120′ may support the dump body 114 of the machine 100.

The ground-engaging members 110 may support the frame 108 on ground at the worksite 102. The ground-engaging members 110 may include a set of front wheels 122 and a set of rear wheels 124. The set of front wheels 122 supports the front frame portion 120, and the set of rear wheels 124 supports the rear frame portion 120′. In some embodiments, the ground-engaging members 110 may include crawler tracks (not shown) provided either alone or in combination with the wheels 122, 124. The front wheels 122 and the rear wheels 124 may be powered by the propulsion system 112 to propel and transport the machine 100 across an expanse of the worksite 102, according to any customary practice known in the art. As an example, a payload received in the dump body 114 may be transported from one location at the worksite 102 to another location at the worksite 102.

The propulsion system 112 may include a power compartment 112′ and a power source (not shown), such as an internal combustion engine, provided within the power compartment 112′. The power source may be configured to power operations of various systems on the machine 100, typically by combusting fuel. Optionally, the propulsion system 112 may also include an electrical power source, applicable either alone or in combination with the internal combustion engine.

The operator cabin 116 may be supported over the frame 108 (e.g., on the front frame portion 120). The operator cabin 116 may facilitate stationing of one or more operators therein, to monitor the operations of the machine 100. Also, the operator cabin 116 may house various components and controls of the machine 100, access to one or more of which may help the operators to control the machine's movement and/or operation. For example, the various components and controls of the machine 100 may include one or more steering wheels, touch screens, display devices, joysticks, switches etc., to facilitate an operator in operating the machine 100 and the dump body 114.

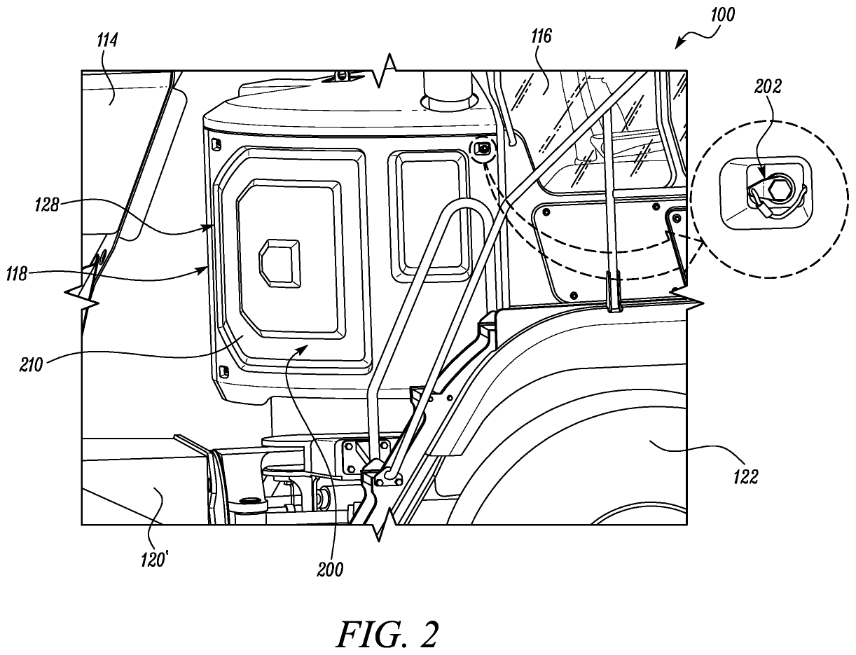

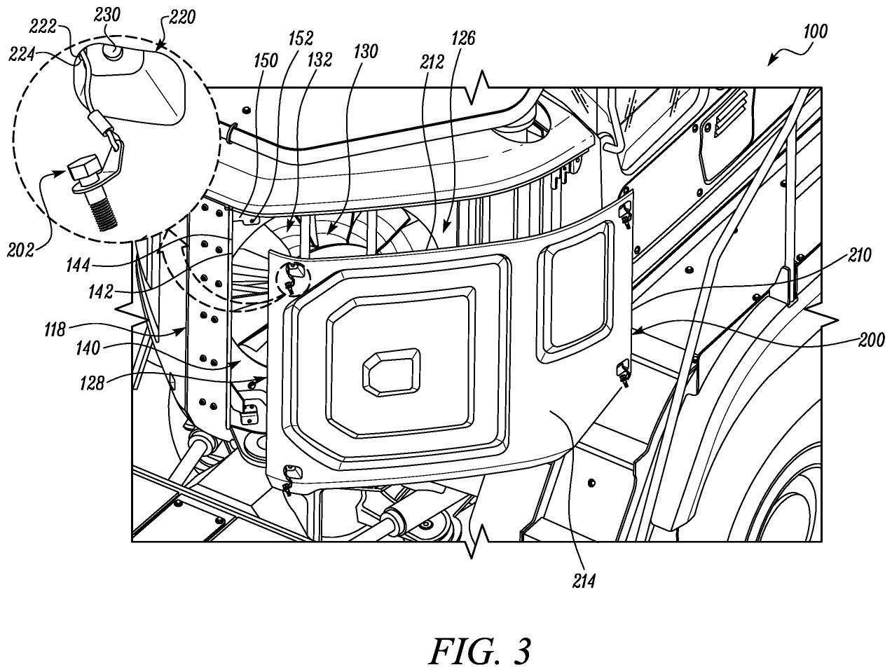

Referring to FIGS. 2 and 3, the radiator housing 118 may include a housing chamber 126 and a guard assembly 128. The housing chamber 126 may house one or more arrangements 130, such as a radiator fan arrangement 132 (please see FIG. 3), that may work in conjunction with the power source of the propulsion system 112 to maintain suitable working temperatures at the power source and/or within the operator cabin 116, in a known manner. The radiator housing 118 may be mounted on the frame 108 (or the front frame portion 120) between the operator cabin 116 and the dump body 114, as shown in FIG. 1.

The radiator housing 118 (or the machine 100) defines an entrance 140 to access the arrangement 130 (or the radiator fan arrangement 132) within the housing chamber 126. A peripheral edge 142 of the radiator housing 118 is defined around the entrance 140 and defines a portion 144 of the radiator housing 118. As shown in FIG. 3, the portion 144 may at least partially surround the radiator fan arrangement 132. The portion 144 (or the peripheral edge 142) defines at least one mounting structure (e.g., mounting structure 150). The mounting structure 150 may include a mounting hole 152. In some cases, the mounting hole 152 may include a threaded hole. In the present embodiment, in total four mounting structures, such as the mounting structure 150, are defined at the portion 144 of the machine 100. The remaining mounting structures may be similar to the mounting structure 150 in construction and configuration, and hence will not be discussed. Further, higher or lesser number of the mounting structures, such as the mounting structure 150, may be provided at various locations on the portion 144 of the machine 100.

Referring to FIGS. 1, 2, and 3, the guard assembly 128 is discussed. The guard assembly 128 includes a structure 200 and a system 202 for fastening the structure 200 to the portion 144 of the machine 100. Details related to each of the structure 200 and the system 202 will be discussed below.

The structure 200 is configured to be coupled to the portion 144 of the radiator housing 118 (or the machine 100) to guard or shield the radiator fan arrangement 132 from the outside of the machine 100. To this end, the structure 200 may include or may embody a guard panel 210 that defines an edge 212. When coupling the structure 200 (or the guard panel 210) to the portion 144 or the peripheral edge 142, the edge 212 sits against the portion 144 or the peripheral edge 142 of the radiator housing 118 to be fastened thereof. In that manner, the structure 200 (or the guard panel 210) may close the entrance 140 of the radiator housing 118 to block the housing chamber 126 from any outside access (e.g., direct operator access) to the radiator fan arrangement 132.

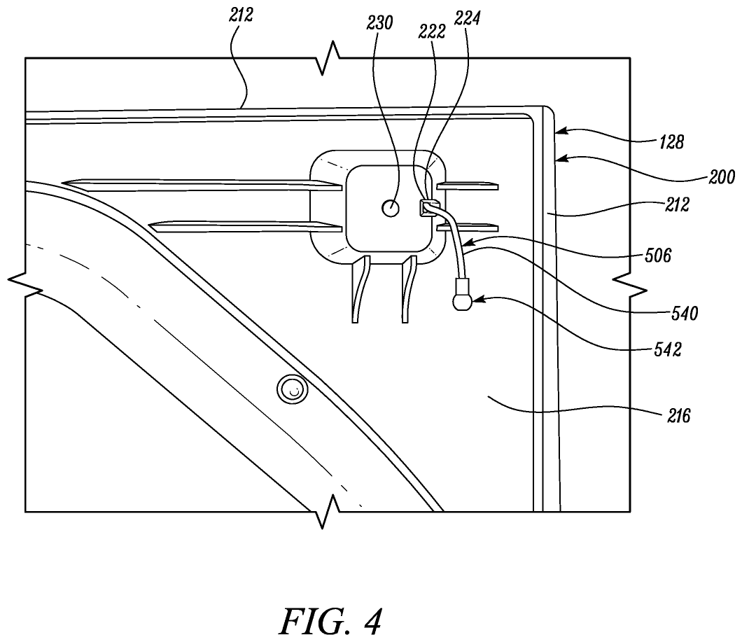

The structure 200 (or the guard panel 210) defines an outer surface 214 and an inner surface 216 opposite to the outer surface 214 (also see FIG. 4). The outer surface 214 faces outwardly away from the entrance 140, and the inner surface 216 faces inwardly towards the entrance 140 when the structure 200 (or the guard panel 210) is coupled to the portion 144 of the radiator housing 118. Also, the structure 200 (or the guard panel 210) defines at least one fastener receptacle 220 and at least one engagement portion 222. The fastener receptacle 220 may include a hole 230 that may be a through hole that extends between the outer surface 214 and the inner surface 216 of the structure 200 (or the guard panel 210). In the present embodiment, four fastener receptacles, such as the fastener receptacle 220, having corresponding holes, such as the hole 230, are defined on the structure 200 (or the guard panel 210). The remaining fastener receptacles and the corresponding holes are similar to the fastener receptacle 220 and the hole 230 in construction and configuration, and hence will not be discussed. Further, higher or lesser number of fastener receptacles may be provided on the structure 200 (or the guard panel 210), and may correspond or may be equal with the number of mounting structures provided at the portion 144 of the machine 100.

The engagement portion 222 includes a slot 224. The slot 224 extends between the outer surface 214 and the inner surface 216 of the structure 200 (or the guard panel 210). The engagement portion 222 (or the slot 224) is defined near the hole 230 of the fastener receptacle 220. In the present embodiment, four engagement portions or slots, such as the engagement portion 222 or the slot 224, are defined on the structure 200 (or the guard panel 210). The remaining engagement portions or the slots are similar to the engagement portion 222 or the slot 224 in construction and configuration, and hence will not be discussed. Further, higher or lesser number of engagement portions or slots may be provided on the structure 200 (or the guard panel 210), and may correspond or may be equal with the number of mounting structures provided at the portion 144 of the machine 100.

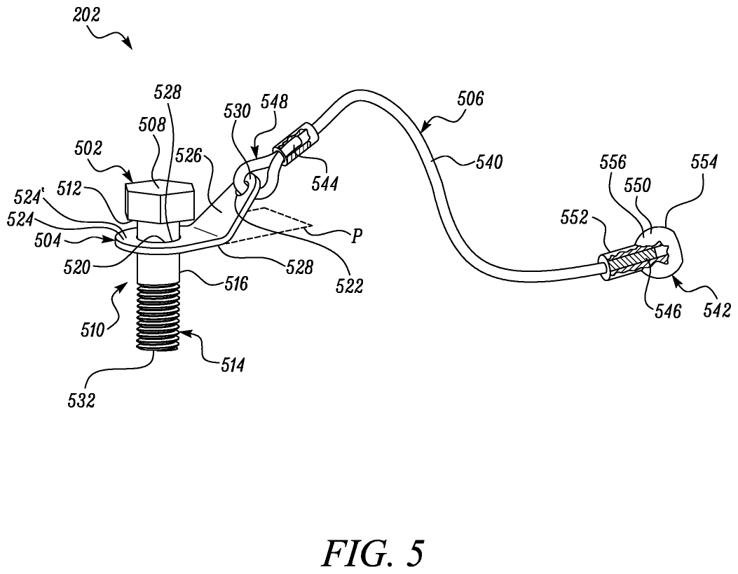

Referring to FIG. 5, the system 202 is discussed. The system 202 is configured to fasten the structure 200 (or the guard panel 210) to the portion 144 of the machine 100. Also, the system 202 is configured to be retained with or tethered to the structure 200 (or the guard panel 210) when the structure 200 (or the guard panel 210) is disassembled from the portion 144 of the machine 100. The system 202 includes a fastener 502, a washer piece 504, and a flexible tether 506.

The fastener 502 defines a head portion 508 and a shank portion 510. The head portion 508 defines a bottom surface 512. The head portion 508 may include one of a hexagonal head portion or a circular profile. The shank portion 510 defines a threaded portion 514 and an unthreaded portion 516. The unthreaded portion 516 extends between the head portion 508 and the threaded portion 514. In the present embodiment, a diameter of the unthreaded portion 516 is less than an outer diameter of the threaded portion 514. Moreover, a cross-sectional area defined by the unthreaded portion 516 may be lesser than an area defined by the bottom surface 512 of the head portion 508. Alternatively, if the head portion 508 includes a circular profile, a diameter of the unthreaded portion 516 may be lesser than a diameter of the head portion 508.

The washer piece 504 defines an opening 520 and an aperture 522. The opening 520 is configured to receive the unthreaded portion 516 of the fastener 502. In this regard, the opening 520 defines a diameter that is greater than the diameter of the unthreaded portion 516. Also, the diameter of the opening 520 is less than a diameter (e.g., the outer diameter) of the threaded portion 514. In that manner, the opening 520 allows a passage of the unthreaded portion 516 of the shank portion 510 therethrough but restricts the passage of the threaded portion 514 or the head portion 508 therethrough. In some embodiments, an area defined by the opening 520 may be smaller than the area defined by the bottom surface 512 of the head portion 508. Alternatively, if the head portion 508 includes a circular profile, the diameter of the opening 520 may be less than a size (e.g., diameter) of the head portion 508 to restrict a passage of the head portion 508 through the opening 520. Further, the washer piece 504 is rotatably disposed around the unthreaded portion 516. In that manner, the washer piece 504 may move or rotate freely with respect to the unthreaded portion 516.

Further, the washer piece 504 may define a washer portion 524 and a protruded portion 526. The washer portion 524 may define a planar annular body 524′ defining an inner periphery 528 and an outer periphery 528″. The planar annular body 524′ extends along a plane, P, from the inner periphery 528 to the outer periphery 528′. The washer portion 524 may be configured to abut against the bottom surface 512 of the head portion 508. The protruded portion 526 may extend angularly away from the washer portion 524 (e.g., from the outer periphery 528′) with respect to the plane, P, defined by the washer portion 524. As shown in FIG. 5, the aperture 522 is formed at the protruded portion 526 of the washer piece 504. For example, the protruded portion 526 may define an end or a tip 530 remote to the outer periphery 528′ of the washer portion 524, and the aperture 522 may be defined at the tip 530 of the protruded portion 526. Further, the washer portion 524 and the protruded portion 526 may be integrally formed—although, in some cases, it is possible for the washer portion 524 and the protruded portion 526 to be separate, individual components that may be coupled to each other by way of conventional industrial fastening techniques (e.g., welding).

With regard to an exemplary assembly process of the washer piece 504 between the head portion 508 and the threaded portion 514, the shank portion 510 (with an unformed threaded portion 514) may be first inserted into the opening 520 of the washer piece 504. Once the washer piece 504 is disposed and/or placed around the shank portion 510, the threaded portion 514 may be formed on the shank portion 510, e.g., by a roll threading process or other known thread formation processes. Exemplarily, such a process may start from an end 532 of the shank portion 510 and may move towards the head portion 508 to form the threaded portion 514, up until a point where the threaded portion 514 is required on the shank portion 510. The threaded portion 514, once formed, may include an outer diameter greater than the diameter of the unthreaded portion 516 and which may also be greater than the diameter of the opening 520 of the washer piece 504. In that manner, the washer piece 504 may be prevented from slipping out of the shank portion 510 and may thus be retained between the head portion 508 and the threaded portion 514. In some cases, additional washer pieces or conventional washers may be disposed and retained between the head portion 508 and the threaded portion 514 along with the washer piece 504.

Details related to the flexible tether 506 shall now be discussed. The flexible tether 506 may include an elongated string 540 having a first end 544 and a second end 546. The flexible tether 506 may be able to accommodate flexures along its length such that one portion of the flexible tether 506 may be bent or twisted freely (e.g., with minimum restriction) with respect to the other portion of the flexible tether 506. In some cases, the flexible tether 506 may be formed from multiple loops (e.g., of metallic or non-metallic material) that are inter engaged sequentially, one after the other, forming a single elongated flexible chain of loops, while, in other embodiments, the flexible tether 506 may take the form of a rope or a lanyard.

With regard to the first end 544 of the flexible tether 506, the first end 544 is coupled or engaged with the washer piece 504. In this regard, the flexible tether 506 may include a loop 548 at the first end 544 that passes through the aperture 522 of the washer piece 504 to engage the flexible tether 506 with the washer piece 504. In some embodiment, the loop 548 may be formed by passing the first end 544 of the flexible tether 506 through the aperture 522 and then coupling the first end 544 with a remaining portion of the flexible tether 506.

With regard to the second end 546 of the flexible tether 506, at the time of an assembly of the system 202 with the structure 200, the second end 546 of the flexible tether 506 may be inserted and be passed through the engagement portion 222 (or the slot 224), so as to move across from the outer surface 214 and towards and beyond the inner surface 216 of the structure 200. Aspects related to the use of the second end 546 is discussed further below.

The second end 546 of the flexible tether 506 includes a retention member 542. The retention member 542 may be configured to be coupled to the second end 546 of the flexible tether 506 (e.g., once the second end 546 is passed through the engagement portion 222 or the slot 224). In this regard, the retention member 542 may include a body 550 defining a stem 552 and an enlarged portion 554—the term ‘enlarged’ as used for the enlarged portion 554 may mean to include a surface 556 on the enlarged portion that is large enough to prevent its passage through the slot 224, or that the surface 556 has a size greater than a cross-sectional area of the slot 224 to keep the retention member 542 from passing through the slot 224. The stem 552 may be coupled to the second end 546 of the flexible tether 506 to couple the retention member 542 with the second end 546 of the flexible tether 506. For example, the stem 552 of the retention member 542 may be fused or crimped with the second end 546 of the flexible tether 506 through a suitable swaging operation—e.g., by use of a crimping or a swaging tool. In other embodiments, any other suitable coupling operation, welding, or brazing, or one that may help attain an interference fit between the stem 552 and the second end 546, as known in the art, may be utilized to couple the stem 552 with the second end 546 of the flexible tether 506.

With the second end 546 passed through the engagement portion 222 (or the slot 224) and the retention member 542 coupled to the second end 546, the retention member 542 is configured to cooperate with the engagement portion 222 (or the slot 224) of the structure 200, to secure the flexible tether 506 from being withdrawn from the structure 200. For example, once the second end 546 of the flexible tether 506 is passed through the engagement portion 222 (in a direction from the outer surface 214 towards the inner surface 216 of the structure 200) and is coupled to the retention member 542, the surface 556 of the retention member 542 may abut and interfere against the engagement portion 222 (or the slot) thereby disallowing the retention member 542 from passing through the slot 224, and in turn securing the flexible tether 506 from being withdrawn from the structure 200.

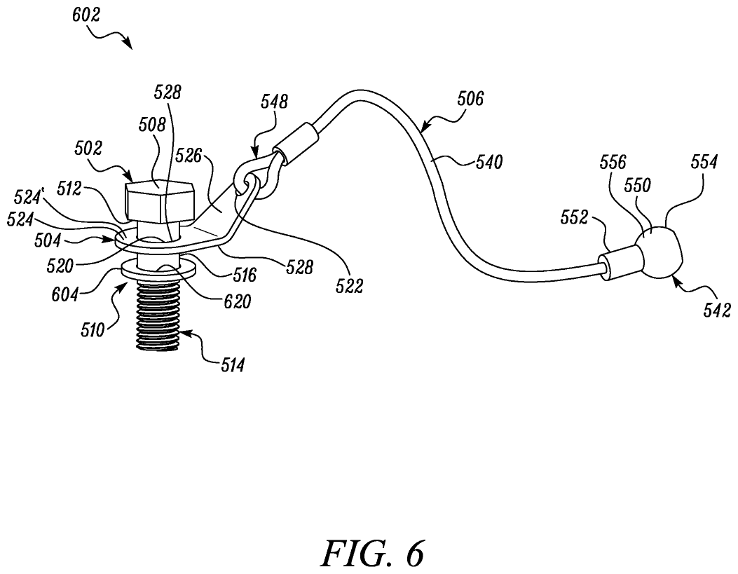

Referring to FIG. 6, a system 602 is shown. The system 602 may be similar in all respects to the system 202 but may differ from the system 202 in that the system 602 further includes an additional washer piece 604. The additional washer piece 604 may be rotatably disposed around the unthreaded portion 516 of the shank portion 510 and may include an opening 620 of the same size as the opening 520. The additional washer piece 604 may be retained between the washer piece 504 and the threaded portion 514 of the shank portion 510. The additional washer piece 604 may define a surface area larger than a surface area defined by the washer piece 504 for contact with the structure 200. The larger surface area of the additional washer piece 604 may facilitate distribution of forces generated during tightening the fastener 502 when fastening the structure 200 to the portion 144 of the machine 100. An exemplary assembly process of the additional washer piece 604 between the washer piece 504 and the threaded portion 514 of the shank portion 510 may include moving and arranging the additional washer piece 604 onto the shank portion 510 before forming the threaded portion 514 on the shank portion 510, such that the additional washer piece 604 may be retained between the washer piece 504 and the threaded portion 514.

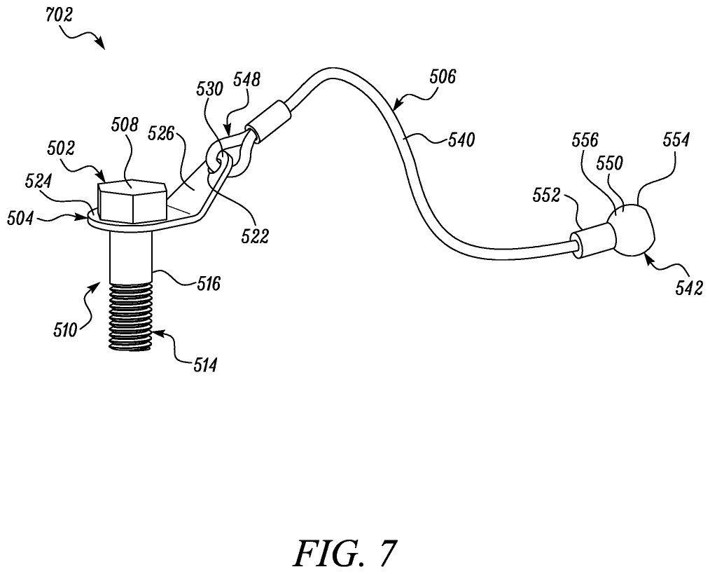

Referring to FIG. 7, a system 702 is shown. The system 702 may be similar in all respects to the system 202 but may differ from the system 202 in that the washer piece 504 is fixedly or immovably disposed around the unthreaded portion 516 of the fastener 502. In an example, the washer piece 504 may be welded to the bottom surface 512 of the head portion 508 of the fastener 502. In another example, the washer piece 504 may be integrally formed with the head portion 508 or the unthreaded portion 516.

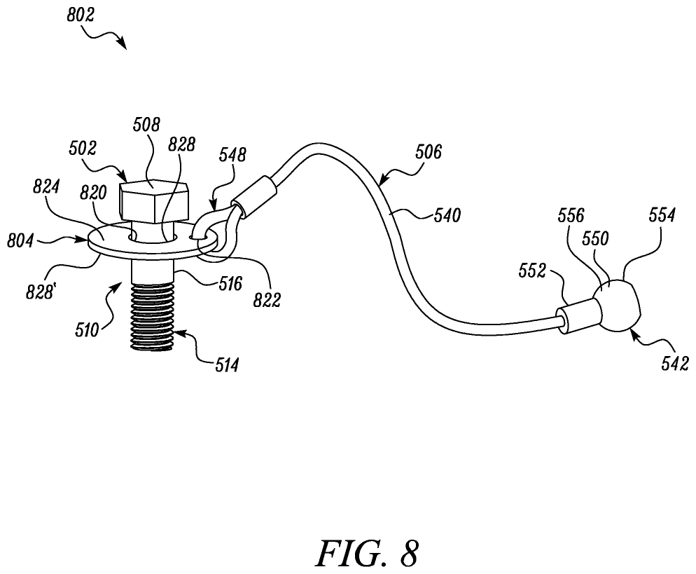

Referring to FIG. 8, a system 802 is shown. The system 802 may be similar in many respects to the system 202 but may differ from the system 202 in that the system 802 includes a washer piece 804 that includes a washer portion 824, similar to the washer portion 524, but in which the protruded portion 526 is altogether omitted. The washer portion 824 defines an opening 820, similar to the opening 520. The washer portion 824, in contrast to the configuration of the washer portion 524 in FIG. 5, includes an aperture 822 within a region defined between an inner periphery 828 and an outer periphery 828′ of the washer portion 824. While the aperture 822 formed in the washer portion 824 may remain similar in size and profile to the aperture 522, the aperture 822 may be located closer to the outer periphery 828′ than to the inner periphery 828, such that the aperture 822 may remain revealed or exposed outwardly of the head portion 508 of the fastener 502 so as to be accessed, tied in, and be engaged with the loop 548, during an assembly of the structure 200 to the portion 144 of the machine 100. An assembly process of the washer piece 804 between the head portion 508 and the threaded portion 514 of the shank portion 510 may remain similar to one or more of the processes discussed supra.

### INDUSTRIAL APPLICABILITY

Structures, such as the structure 200 (or the guard panel 210), are generally applied to shield arrangements, such as the radiator fan arrangement 132 installed on the machine 100, from direct access (e.g., direct operator access). During assembling or disassembling the structure 200, loss, or misplacement of the hardware, or at least one fastener and/or washer, may make placing the structure 200 against the portion 144 of the machine 100 difficult. Even if the remaining hardware, or fasteners and washers, are used to fasten the structure 200, certain sections of the structure 200 may still attain an improper fit against the portion 144 of the machine 100. Such sections may bend and/or break away from the remaining section of the structure 200 over prolonged cycles of machine use if the lost hardware or fastener or washer is not replaced with a new one. The present disclosure provides the system 202, 602, 702, and 802, that is prevented from being lost or misplaced from the structure 200.

An exemplary method of assembling the system 202 of FIG. 5 or system 802 of FIG. 8, onto or against the structure 200 to form the guard assembly 128 is now discussed. Initially, an operator may pass the first end 544 of the flexible tether 506 through the aperture 522 or the aperture 822 to form the loop 548 to engage the first end 544 of the flexible tether 506 with the washer piece 504 or the washer piece 804. Additionally, the operator may also pass the second end 546 of the flexible tether 506 through the engagement portion 222 (or the slot 224) of the structure 200, exemplarily, in the direction from the outer surface 214 towards the inner surface 216 of the structure 200. Once the second end 546 of the flexible tether 506 passes towards and beyond the inner surface 216 of the structure 200, the operator couples the retention member 542 to the second end 546 via a suitable coupling operation, such as swaging. In that manner, the flexible tether 506 is secured to the structure 200, and hence, the system 202 or the system 802 is retained or tethered with the structure 200.

The guard assembly 128, having the structure 200 and the system 202, 802, retained thereto, is thus formed. Thereafter, the operator may bring forth the guard assembly 128 towards the portion 144 of the machine 100, such that the edge 212 of the structure 200 is seated against the portion 144 (or the peripheral edge 142) of the radiator housing 118, and the hole 230 defined at the structure 200 is aligned with the corresponding mounting hole 152 of the portion 144 of the machine 100. Once the structure 200 is placed at the portion 144, the operator inserts and drives the fastener 502 through the fastener receptacle 220 into the corresponding hole 230, and further into the corresponding mounting hole 152 by way of a suitable tool. Next, the fastener 502 is tightened by applying torque, to appropriately fasten and secure the structure 200 to the portion 144 of the machine 100.

An exemplary method of assembling the system 602 of FIG. 6, onto the structure 200 to form the corresponding guard assembly may be similar in all respects to the method of assembling the system 202 discussed above, but differs in that the additional washer piece 604 is disposed around the unthreaded portion 516 and is retained between the washer piece 504 and the threaded portion 514. When disposed around the unthreaded portion 516, the additional washer piece 604 may provide a larger surface area for contact with the structure 200 as compared to the surface area defined by the washer piece 504, had the washer piece 504 been available for contact with the structure 200. The larger surface area of the additional washer piece 604 allows forces generated during the tightening of the fastener 502 to be properly and or evenly distributed to the structure 200.

In the case of the system 202, system 602, and system 802, the washer piece 504 or the washer piece 804 may be freely and rotatably disposed around the unthreaded portion 516 of the fastener 502. This prevents undue coiling and twisting of the flexible tether 506 over and against the fastener 502. Further, an exemplary method of assembling the system 702 of FIG. 7, onto the structure 200 may be similar in all respects to the method of assembling the system 202, of FIG. 5, but differs in that the washer piece 504 is fixedly coupled (e.g., welded) to the head portion 508 of the fastener 502.

The above-described system 202, 602, 702, or 802, for fastening the structure 200 (or the guard panel 210) to the portion 144 of the machine 100 is formed of easily available components, is cost-effective, and is highly reliable. Utilizing the system 202, 602, 702, or 802, may mitigate a risk of loss or misplacement of either a specific component or the whole system when the structure 200 is assembled or disassembled from the portion 144 of the machine 100.

Although the concepts of the present disclosure are discussed in the context of the structure 200 (or the guard panel 210) that blocks access to the radiator fan arrangement 132 of the machine 100, the system 202, 602, 702, and 802, may be suitably applied to fasten any part on any machine. Further, it may be noted that one or more components of one system, as discussed herein, may be combinedly and suitably used with one or more components of another system, as discussed herein.

It will be apparent to those skilled in the art that various modifications and variations can be made to the system of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalent.

1. A system for fastening a structure to a portion of a machine, the system comprising:
a fastener defining a head portion and a shank portion, the shank portion defining a threaded portion and an unthreaded portion, the unthreaded portion extending between the head portion and the threaded portion;
a washer piece disposed around the unthreaded portion and being retained between the head portion and the threaded portion of the shank portion; and
a flexible tether having a first end and a second end, wherein the first end is coupled with the washer piece and the second end includes a retention member for securing the flexible tether to the structure.

2. The system of claim 1, wherein the structure defines an engagement portion including a slot, the flexible tether passable through the slot, and the retention member defines a surface having a size greater than a cross-sectional area of the slot to keep the retention member from passing through the slot.

3. The system of claim 1, wherein the washer piece defines an aperture, and the flexible tether includes a loop at the first end passing through the aperture to engage the flexible tether to the washer piece.

4. The system of claim 3, wherein the washer piece defines a washer portion and a protruded portion,
wherein the protruded portion extends angularly away from the washer portion with respect to a plane defined by the washer portion, and
wherein the aperture is formed in the protruded portion of the washer piece.

5. The system of claim 1, wherein the washer piece defines an opening for passage of the unthreaded portion therethrough, and wherein a diameter of the opening is less than each of a diameter of the threaded portion and a size of the head portion.

6. The system of claim 1, wherein the washer piece is disposed rotatably around the unthreaded portion of the shank portion.

7. The system of claim 1, wherein the washer piece is fixedly coupled to the head portion of the fastener.

8. The system of claim 1 further comprising an additional washer piece disposed rotatably around the unthreaded portion and being retained between the washer piece and the threaded portion of the shank portion, wherein a surface area defined by the additional washer piece is larger than a surface area defined by the washer piece for contact with the structure.

9. A machine, comprising:
a portion at least partially surrounding an arrangement; and
a guard assembly, including:
a structure defining an engagement portion; and
a system for fastening the structure to the portion of the machine, the system including:
a fastener defining a head portion and a shank portion, the shank portion defining a threaded portion and an unthreaded portion, the unthreaded portion extending between the head portion and the threaded portion;
a washer piece disposed around the unthreaded portion and being retained between the head portion and the threaded portion of the shank portion; and
a flexible tether having a first end and a second end, wherein the first end is coupled with the washer piece and the second end includes a retention member for securing the flexible tether to the structure.

10. The machine of claim 9, wherein the engagement portion includes a slot, the flexible tether passable through the slot, and the retention member defines a surface having a size greater than a cross-sectional area of the slot to keep the retention member from passing through the slot.
